(19) United States
(12) Patent Application Publication
(10) Pub. No.: US 2019/0359283 A1
(43) Pub. Date: Nov. 28, 2019

(54) Reciprocating Action Drive with Elastically Extensible Reversing Mechanism

(71) Applicant: Roy Rosser, Monmouth Junction, NJ (US)

(72) Inventor: Roy Rosser, Monmouth Junction, NJ (US)

(21) Appl. No.: 16/200,209

(22) Filed: Nov. 26, 2018

Related U.S. Application Data
(60) Provisional application No. 62/590,940, filed on Nov. 27, 2017.

(51) Int. Cl. B62M 1/28; F16H 19/06; F16H 31/00; F16D 27/01; F16D 27/14; F16D 41/06

(52) U.S. Cl. CPC B62M 1/28; F16H 19/06; F16H 31/001; F16D 2041/0603; F16D 27/14; F16D 41/06; F16D 27/01

(57) ABSTRACT

A reciprocating action drive having an elastically extensible reversing mechanism is disclosed in which drive levers are connected to a driven shaft by overrunning clutches such that when the levers are moved in a first direction, the shaft is driven, but when moved in a counter-rotating direction, it is not. The extensible reversing mechanism links the levers such that, when not extended, it causes the two levers to counter-rotate, only allowing one to drive the shaft. However, when the lever being moved in the non-driving direction changes direction, the reversing mechanism extends and does not immediately cause the other lever to change direction, but allows it to continue to move in the driving direction. Both levers may, therefore, simultaneously drive the driven shaft for as long as the extensible reversing mechanism extends, allowing latitude for unsynchronized reciprocating motions to be applied without them competing against each other.

### CROSS-REFERENCE TO RELATED APPLICATIONS

This application claims priority to U.S. Ser. No. 62/590,940 filed Nov. 27, 2017, by Roy Rosser entitled “Reciprocating Action Drive with Elastically Extensible Reversing Mechanism”, the contents of which are fully incorporated herein by reference.

### BACKGROUND OF THE INVENTION

### (1) Field of the Invention

The invention relates to reciprocating action drives having elastically extensible reversing mechanisms, or elements, and more particularly to such drives that incorporate an elastomer element with elastic hysteresis, allowing both a springing and a damping action.

### (2) Description of the Related Art

The technical problem of converting reciprocating motion to uni-directional rotary motion is inherent in the technical field of engineering mechanical devices.

Early forms of converting reciprocating motion into rotary motion, such as bow lathes, resulted in bi-directional, or oscillating, rotary motion that was satisfactory for tasks such as rudimentary wood turning, but is unsuitable for propelling wheeled vehicles that require uni-directional rotary motion.

The earliest, and still the most widely used, device for converting reciprocating motion to uni-directional rotary motion, is the crank, which appears to have been used in Roman sawmills in Asia Minor as early as the 2nd Century AD.

When converting linear, or substantially liner, reciprocating motion into rotary motion, the crank, however, has a significant drawback. If the forces applied to the crank arms are linear, then at top-dead center and bottom dead center, i.e., when the line of the applied force runs directly through the axis of rotation of a driven shaft, none of the linear force applied is converted into useful rotary motion of the driven shaft. The effective transfer of energy from the applied linear force increases slowly as the crank angle away from top dead center increases, and is approximately proportional to the sine of that crank angle, reaching a maximum at 90-degree crank angle, after which it begins to decrease again, also approximately proportional to the sine of the crank angle, until it is once again zero at 180-degree crank angle, or bottom dead center.

Despite this significant draw back, but because of their extreme simplicity, cranks have been, and still are, the most used device for converting linear, or substantially linear, reciprocating motion to uni-directional rotary motion. They have been, and still are, widely applied in, for instance, steam locomotives, gasoline powered automobiles, and human powered vehicles such as bicycles.

The drawbacks of using cranks, particularly in human powered devices, and alternate methods of converting linear reciprocating motion to uni-directional rotary motion, such as, but not limited to, reciprocation action drives, have been described in detail in, for instance, U.S. Pat. No. 9,829,054 granted to Rosser on Nov. 28, 2017 entitled “Reciprocating action drive”, the contents of which are hereby incorporated by reference in their entirety. Other descriptions may, for instance, be found in WIPO PCT publication WO/2013/052929 entitled “Mechanism for Converting Reciprocating Motion into Rotary Motion” published on Nov. 4, 2013, and in U.S. Pat. No. 8,763,481 issued to Hansen on Jul. 1, 2014 entitled “ Reciprocating lever transmission”.

Hansen, for instance, describes a reciprocating pedal transmission for a pedal-powered vehicle. Two pedals are selectively connected to a driveshaft by one way clutches. A reversing gear mechanism forces the non-pushing pedal to travel in a direction which is opposite to the direction of the pushing pedal. The non-pushing pedal may also be used to input force (a pulling force) if desired. The arcuate range of motion is infinitely variable. The user may reverse the pedal travel at any time using only the forces applied by the feet.

However, like other reciprocating action devices that have a linked reversing mechanism, the linkage is rigid in that the non-pushing pedal is forced in the opposite direction, so that pushing on the pedals must be alternated in perfect synchronicity. Unfortunately, human actions are seldom perfectly synchronized. In riding a bicycle powered using a reciprocating action device having a rigid linked reversing mechanism, if, for instance, the left foot starts to push down before the right foot has completed pushing down, the two work against each other. Not only does this reduce the efficiency of the vehicle, but it also makes it uncomfortable to ride.

What is needed is a reciprocating action device having a linked reversing mechanism that has sufficient latitude to allow slightly unsynchronized reciprocation motions to power it with little or no loss of efficiency.

### BRIEF SUMMARY OF THE INVENTION.

Innovative reciprocating action drives having elastically extensible reversing mechanisms are disclosed.

In a preferred embodiment, the elastically extensible reciprocating action drive may include two drive levers that may be connected to a common driven shaft by two overrunning clutches. One of the overrunning clutches may connect a first drive lever to the driven shaft such that when the first drive lever is moved in a first rotation direction, the shaft is driven, but when the first drive lever is moved in a second, counter-rotating direction, the shaft is not driven.

Similarly, the second overrunning clutches may connect the second drive lever to the driven shaft such that when the second drive lever is moved in the first rotation direction, the shaft is driven, but when the second drive lever is moved in the second, counter-rotating direction, the shaft is not driven.

The elastically extensible reversing mechanism may link the drive levers such that, when the mechanism is not extended, it causes the two drive levers to counter-rotate, i.e., one to move in the first rotation direction and the other in the second, counter rotation direction. Therefore, when not extended, the elastically extensible reversing mechanism only allows one of the drive levers to drive the driven shaft. However, because the reversing mechanism is extensible, when the drive lever that is being moved in the counter-rotating, non-driving direction changes direction, the reversing mechanism may begin to extend and may not immediately cause the other drive lever to change direction, but instead may allow it to continue to be driven in the first, driving direction. In this way, both drive levers may simultaneously drive the driven shaft. This duel driving may last for as long as the elastically extensible reversing mechanism can be extended. This may only be for a short rotational distance, but it may allow sufficient latitude for slightly unsynchronized reciprocating motions to be applied without them competing against each other.

In a further preferred embodiment of the invention, the drive levers may be reversibly connected by a series of beveled gears that may include one or more extensible elements. These extensible elements may, for instance, include an elastomer element that may, for instance, be made of a polyurethane or a rubber, or a combination thereof.

Alternatively, the elastically extensible reversing mechanism may consist of a flexible cable configured to pass over a pivot, or pully. Such an arrangement may, for instance, be used in powering a bicycle. The flexible cable may, for instance, be made of an elastomer such as, but not limited to, a polyurethane or a rubber, or a combination thereof.

In a further preferred embodiment of the invention, one or more of the overrunning clutches may be a magnetically hinged overrunning clutch. Such a magnetically hinged overrunning clutch may have one or more pivoting sprags that may include a permanent magnet, or it may have one or more pseudo-spirals sprags that may include a permanent magnet.

Therefore, the present invention succeeds in conferring the following, and others not mentioned, desirable and useful benefits and objectives.

It is an object of the present invention to provide a functional, easy to make and easy to use reciprocating action drive.

### BRIEF DESCRIPTION OF THE SEVERAL VIEWS OF THE DRAWINGS.

FIG. 1A shows a schematic, plan view of one embodiment of a reciprocating action drive with an elastically extensible reversing mechanism of the present invention.

FIG. 1B shows a schematic, side view of one embodiment of a reciprocating action drive with an elastically extensible reversing mechanism of the present invention.

FIG. 2 shows a schematic, plan view of one embodiment of an elastically extensible reciprocating action drive with beveled gears of the present invention.

FIG. 3 shows a schematic, isometric view of one embodiment of an elastically extensible reciprocating action drive with a pivoted cable connection of the present invention.

FIG. 4 shows a schematic, side view of one embodiment of an elastically extensible reciprocating action drive of the present invention powering a bicycle.

FIG. 5 shows a schematic, cross-sectional view of a magnetically hinged overrunning clutch as used in one embodiment of the present invention.

FIG. 6 shows a schematic, cross-sectional view of a magnetically hinged overrunning clutch having pseudo-spirals sprags as used in one embodiment of the present invention.

### DETAILED DESCRIPTION OF THE INVENTION

The preferred embodiments of the present invention will now be described in more detail with reference to the drawings in which identical elements in the various figures are, as far as possible, identified with the same reference numerals. These embodiments are provided by way of explanation of the present invention, which is not, however, intended to be limited thereto. Those of ordinary skill in the art may appreciate upon reading the present specification and viewing the present drawings that various modifications and variations may be made thereto without departing from the spirit of the invention.

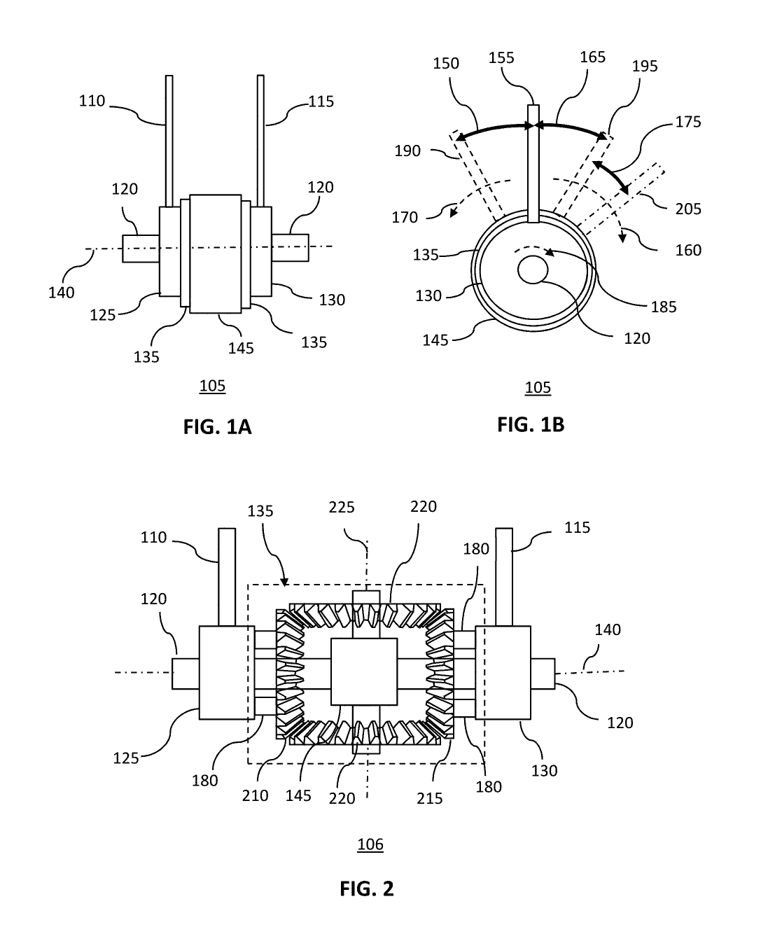

FIG. 1A shows a schematic, plan view of one embodiment of a reciprocating action drive with an elastically extensible reversing mechanism of the present invention.

A first drive lever 110 and a second drive lever 115 may be connected to a driven shaft 120 via, respectively, a first overrunning clutch 125 and a second overrunning clutch 130. The arrangement may be such that a linear, reciprocating motion applied to the drive levers may result in the driven shaft being driven in a rotating motion in a single direction, i.e., the linear reciprocation motion may be converted to continuous, rotary motion in a single direction. The drive levers may also be connected to each other via one or more elastically extensible reversing elements 135. This may, for instance, mean that while the levers are connected such that they initially drive each other in opposite directions, if the motion of one of the levers is stopped, the other may continue its motion under an elastic constraint for a period. This allows a degree of asynchronicity between the drive levers, to the extent that they may briefly both be driven in the same direction despite their functional connection via the reversing elements. This arrangement allows the linear reciprocation motion to be applied in a slightly uncoordinated fashion that may, for instance, allow for a more forgiving mode of operation when the reciprocating action drive is being used to drive a vehicle such as, but not limited to, a bicycle or an electric bicycle.

The driven shaft 120 may be rotatably supported in a support frame 145 and may rotate about an axis of rotation 140 that it may have in common with the overrunning clutches.

FIG. 1B shows a schematic, side view of one embodiment of a reciprocating action drive with an elastically extensible reversing mechanism of the present invention.

The drive levers are shown as having a mean position 155. The drive levers may be connected to a driven shaft 120 via overrunning clutches, one of which is shown in this view as element 130. The drive levers, the over running clutches and the driven shaft may be connected such that a substantially liner reciprocating motion applied to the drive levers may result in the driven shaft 120 being driven in a driven direction of rotation 185.

The drive levers may also be functionally connected via one or more elastically extensible reversing elements 135. These may function such that when the first drive lever is moved in a first direction 160 of rotation, the second drive lever may, as a consequence, be moved in a second, opposite direction 170 of rotation. The second drive lever may, therefore, reach a position 190 when the first drive lever reaches a position 195. The angle 150 of rotation from said mean position reached by the second drive lever may, for instance, be equal in magnitude, but opposite in direction, to the angle of rotation 165 from a mean position reached by the first drive lever. However, if the second drive lever is stopped at the position 190, by, for instance, a driving force beginning to be applied to it in the first rotation direction 160, the elastically extensible reversing mechanism may allow the first drive lever to continue on to position 205. In this way, both drive levers may simultaneously drive the driven shaft. This duel driving may last for as long as the elastically extensible reversing mechanism can be extended. This may only be for a short rotational distance, but it may allow sufficient latitude for slightly unsynchronized reciprocating motions to be applied without them competing against each other.

This extended angle of rotation 175 may be made possible by, for instance, an elastic element, or a spring, in the elastically extensible reversing mechanism 135. The elastic element may, for instance, be an elastomer such as, but not limited to, a polyurethane or a rubber, or a combination thereof. The elastomer element may provide the elastically extensible reversing element with elastic hysteresis, thereby providing both a springing action and a damping of that springing action. This combination of springing and damping may, for instance, allow for a more forgiving use of the reciprocating action drive.

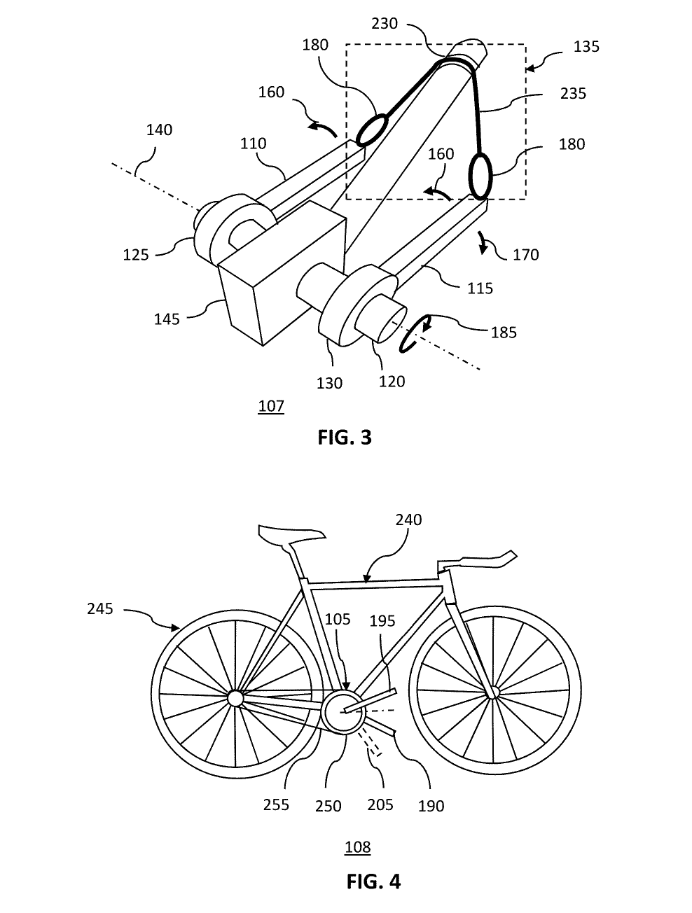

FIG. 2 shows a schematic, plan view of one embodiment of an elastically extensible reciprocating action drive with beveled gears of the present invention.

The elastically extensible reversing mechanism 135 may include a first beveled gear 210 that may be functionally connected to a first drive lever 110 via an outer shell of a first overrunning clutch 125, as well as a first overrunning clutch 125 that may be functionally connected to a second drive lever 115 via an outer shell of a second overrunning clutch 130. This functional connection may be facilitated via one or more elastomer elements 180, thereby providing both a springing and a damping component to the elastically extensible reversing mechanism. The elastomer element 180 be made of an elastic material such as, but not limited to, a rubber or a polyurethane, or a combination thereof, that may exhibit elastic hysteresis.

When moved in a first rotational direction, the first drive lever 110 may drive the driven shaft 120 in that same first rotational direction via the first overrunning clutch 125, with both the first overrunning clutch 125 and the driven shaft 120 rotating about a common axis of rotation 140. At the same time, the second drive lever 115 may be driven in an opposite rotation direction via the elastically extensible reversing mechanism 135. This reversal of direction may, for instance, be effected by one or more third bevel gears 220 that connect said first and second bevel gears, but which are located and oriented to rotate about an axis of rotation 225 orthogonal to the common axis of rotation 140. The driven shaft 120 and the shafts supporting the third bevel gears 220 may all be supported on, a common support frame 145.

FIG. 3 shows a schematic, isometric view of one embodiment of an elastically extensible reciprocating action drive with a pivoted cable connection of the present invention.

In the exemplary embodiment shown schematically in FIG. 3, the elastically extensible reversing mechanism 135 may incorporate a pivot element 230 that may be attached to, or be a part of, the support frame 145. A flexible cable 235 may functionally connect the first drive lever 110 to the elastomer element 180. The flexible cable 235 may be routed through, or around, the pivot element 230 such that when the first drive lever 110 is moved in a first direction 160 of rotation about the common axis of rotation 140, the second drive lever 115 may be moved in a second direction 170 of rotation that is opposite in direction from the first direction of rotation.

The elastically extensible reversing mechanism 135 may also incorporate one or more spring or elastic elements 180 that may functionally, and elastically reversibly, connect said first and second drive levers.

The pivot element 230 may be situated such that the first drive lever is prevented from exceeding a first angle of rotation from a mean position of the drive levers when rotated in a first direction about the axis of rotation 140.

However, when the first drive lever is stopped, the elastically extensible reversing mechanism may allow the second drive lever to continue on to an extended angle of rotation in the opposite rotational direction. This may be made possible by, for instance, a spring, or an elastic element 180, in the elastically extensible reversing mechanism 135. A spring may, for instance, be any suitable mechanical spring such as, but not limited to, a metal or plastic coiled spring. More preferably, the elastic element may be made of an elastomer material such as, but not limited to, a polyurethane or a rubber, or a combination thereof. The elastomer element may provide the elastically extensible reversing element with elastic hysteresis, thereby providing both a springing action and a damping of that springing action. This combination of springing and damping may, for instance, allow for a more forgiving use of the reciprocating action drive.

In a further preferred embodiment of the invention, the entire flexible cable 235 may be the elastic element made of an elastomer material.

FIG. 4 shows a schematic, side view of one embodiment of a elastically extensible reciprocating action drive of the present invention powering a bicycle.

As shown in FIG. 4, a bicycle having a bicycle frame 240 and at least a driven bicycle wheel 245, may be powered using a reciprocating action drive 105 with elastically extensible reversing mechanism. The reciprocating action drive 105 with the elastically extensible reversing mechanism may have a driven shaft that may be functionally connected to a chain ring 250 that may drive the driven bicycle wheel 245 via a bicycle chain 255, as is typical in most bicycles.

As shown in FIG. 4, when being ridden, when the cyclist pushes the first pedal, or first drive lever, down to position 190, the opposite pedal or second drive lever may be moved by the reciprocating action drive 105 up to position 195. However, as the cyclist begins to now push down on the opposite pedal, instead of the reciprocating action drive 105 immediately beginning to force the first pedal to counter rotate, because it is has elastically extensible reversing mechanism, the first pedal may continue to be pushed in the driven direction to position 205.

In this way, both drive levers may simultaneously drive the driven shaft. This duel driving may last for as long as the elastically extensible reversing mechanism can be extended. This may only be for a short rotational distance, but it may allow sufficient latitude for slightly unsynchronized reciprocating motions to be applied without them competing against each other, leading to both a more comfortable and more efficient ride for the cyclist.

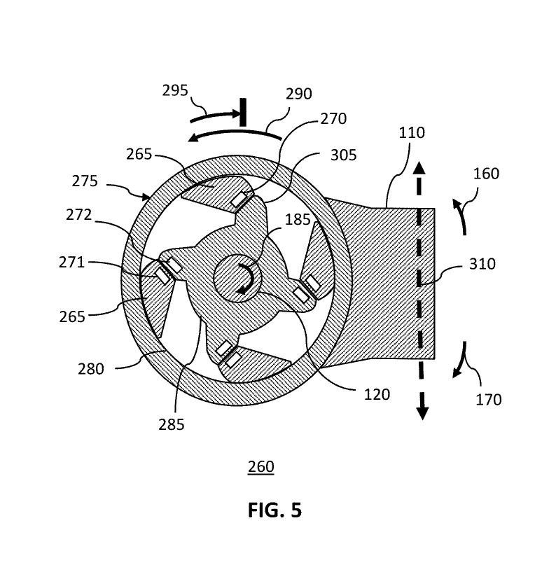

FIG. 5 shows a schematic, cross-sectional view of a magnetically hinged overrunning clutch as used in one embodiment of the present invention.

In the embodiments of the invention described above, one or more of the overrunning clutches may be a magnetically hinged overrunning clutch. One embodiment of such a magnetically hinged, overrunning clutch is shown in FIG. 5.

The magnetically hinged overrunning clutch 260 may have one or more pivoting sprags 265 situated between an inner surface 280 of an outer shaft 275 and an outer surface 285 of the driven shaft 120, or extensions of the driven shaft. The pivoting sprags 265 may have a permanent magnet 270 situated such that the sprag may be attracted to a suitably shaped region 305 of ferromagnetic material that may be connected to, or a part of, the driven shaft.

The arrangement may be such that the outer shaft 275 and the driven shaft 120 are free to rotate past each other when rotated in a free-wheel rotational direction 290 with respect to each other, but are locked together by said pivoting sprags when attempted to be rotated in an opposite, lockup rotational direction 295 with respect to each other.

The driven shaft 120 may also, or instead, have extensions that may incorporate a permanent magnet 272, that may be located so as to attract the permanent magnet 271 that may be a part of a spragg, and so effect the same behavior, i.e., that the outer shaft 275 and the driven shaft 120 are free to rotate past each other when rotated in a free-wheel rotational direction 290 with respect to each other, but are locked together by said pivoting sprags when attempted to be rotated in an opposite, lockup rotational direction 295 with respect to each other.

In such arrangements, a source of linear reciprocating motion 310 may be applied to a first drive lever 110 so that its alternating movement in a first direction 160 of rotation and a second, opposite direction 170 of rotation may be converted into continuous, rotary motion in a driven direction of rotation 185.

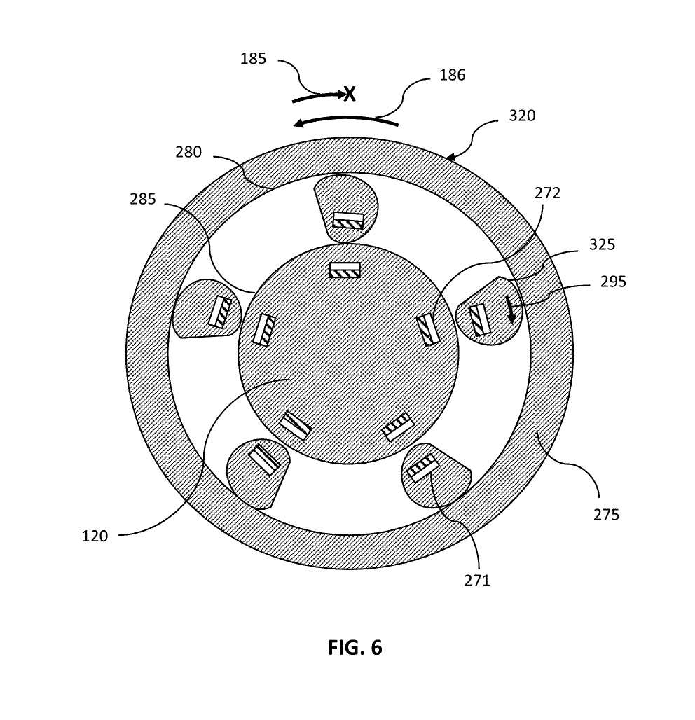

FIG. 6 shows a schematic, cross-sectional view of a magnetically hinged overrunning clutch having pseudo-spirals sprags as used in one embodiment of the present invention. As shown in FIG. 6, the magnetically hinged overrunning clutch may include one or more pseudo-spirals sprags 325, each preferably having a permanent magnet 271 as part of the spragg, situated between the inner surface 280 of an outer driving shell 320 and the outer surface 285 of the driven shaft 120. Such magnetically hinged overrunning clutches are described in more detail in, for instance, in U.S. Pat. No. 9,856,928 issued to Rosser on Jan. 2, 2018 entitled “Magnetically hinged overrunning clutch”, the contents of which are hereby incorporated by reference in their entirety.

When the outer driving shell 320 is moved in the driven direction of rotation 185, the pseudo-spirals sprags 325 may pivot in the lockup direction 295, and may so effectively lock the inner surface 280 of the outer shaft 275 to the outer surface 285 of the driven shaft 120, and may thereby transfer torque from the driving levers to the driven shaft.

When, however, the outer driving shell 320 is moved in the overrunning direction of rotation 186, the pseudo-spirals sprags 325 may pivot backward and the inner surface 280 of the outer shaft 275 may freewheel past the driven shaft 120.

Although this invention has been described with a certain degree of particularity, it is to be understood that the present disclosure has been made only by way of illustration and that numerous changes in the details of construction and arrangement of parts may be resorted to without departing from the spirit and the scope of the invention.

The invention claimed is:

1. A reciprocating action drive, comprising:
a first drive lever and a second drive lever;
a driven shaft;
a first overrunning clutch functionally connecting said first drive lever to said driven shaft such that said first overrunning clutch drives said driven shaft when said first drive lever is moved in a first rotation direction, but not when moved in a second, counter-rotating direction;
a second overrunning clutch functionally connecting said second drive lever to said driven shaft such that said second overrunning clutch drives said driven shaft when said second drive lever is moved in said first rotation direction, but not when moved in said second, counter-rotating direction; and
an elastically extensible reversing mechanism functionally connecting said first drive lever to said second drive lever such that, when not extended, said elastically extensible reversing mechanism causes said first and second drive levers to counter rotate with respect to each other, with only one of said overrunning clutches driving said driven shaft but, while being extended, allows both said first and second drive levers to move in said first direction, thereby allowing both said overrunning clutches to simultaneously drive said driven shaft.

2. The reciprocating action drive of claim 1, wherein said first and second overrunning clutches are coaxially located with respect to each other and to said driven shaft.

3. The reciprocating action drive of claim 2, wherein, said driven shaft rotates about a common axis of rotation that is fixed with respect to a support frame, and wherein, when not extended, said elastically extensible reversing mechanism prevents said first and second drive levers from exceeding a first relative angle of rotation with respect to each other, but when extended, said elastically extensible reversing mechanism enables said first and second drive levers rotate to an extended, relative angle of rotation with respect to each other.

4. The reciprocating action drive of claim 1, wherein, said elastically extensible reversing mechanism further comprises an elastomer element, thereby providing said elastically extensible reversing element with elastic hysteresis.

5. The reciprocating action drive of claim 4, wherein, said elastomer element is comprised of one of a polyurethane and a rubber, or a combination thereof.

6. The reciprocating action drive of claim 1, wherein, said elastically extensible reversing mechanism further comprises a first beveled gear functionally connected to said first drive lever; a second beveled gear functionally connected to said second drive lever; one or more third bevel gears functionally connecting said first beveled gear to said second beveled gear; and, wherein, said functional connection between said first drive lever and said first beveled gear comprises an elastomer element.

7. The reciprocating action drive of claim 6, wherein, said elastomer element is comprised of one of a polyurethane and a rubber, or a combination thereof.

8. The reciprocating action drive of claim 3, wherein, said elastically extensible reversing mechanism further comprises a pivot element connected to said frame, and a flexible cable configured to pass over said pivot, and to functionally, and elastically reversibly, connect said first and second drive levers.

9. The reciprocating action drive of claim 1, further comprising a bicycle frame and a driven bicycle wheel, and wherein said driven shaft is functionally connected to said driven bicycle wheel via a chain ring and a bicycle chain.

10. The reciprocating action drive of claim 1, wherein, at least one of said overrunning clutches is a magnetically hinged overrunning clutch.

11. The reciprocating action drive of claim 10, wherein, said magnetically hinged overrunning clutches has one or more pivoting sprags comprising a permanent magnet.

12. The reciprocating action drive of claim 10, wherein, at least one of said overrunning clutches has one or more pseudo-spirals sprags comprising a permanent magnet.

13. The reciprocating action drive of claim 10, wherein, said magnetically overrunning clutch further comprises an outer shaft disposed to rotate about a common axis of rotation; and wherein said one or more pivoting sprags are located between an inner surface of said outer shaft and an outer surface of said driven shaft, and, wherein, said pivoting sprags are shaped and sized, and sprung and located by magnetic attraction, such that said outer shaft and said driven shaft are free to rotate past each other when rotated in a free-wheel rotational direction with respect to each other, but are locked together by said pivoting sprags when attempted to be rotated in an opposite, lockup rotational direction with respect to each other.

14. A reciprocating action drive, comprising:
a driven shaft;
a first and a second overrunning clutch functionally connected to said driven shaft;
an elastically extensible reversing mechanism; and,
wherein, said elastically extensible reversing mechanism is functionally connected to said overrunning clutches such that, when not extended, only one of said overrunning clutches can drive said driven shaft but, while being extended, both said first and second overrunning clutches can simultaneously drive said driven shaft.

15. The reciprocating action drive of claim 14, wherein, said first and second overrunning clutches are coaxially located with respect to each other and to said driven shaft; and said elastically extensible reversing mechanism comprises an elastomer element.

16. The reciprocating action drive of claim 14, wherein, at least one of said overrunning clutches is a magnetically hinged overrunning clutch.

17. A reciprocating action drive, comprising:
a driven shaft;
a first and a second overrunning clutch, each having an outer driving shell, and both being functionally connected to said driven shaft, and, wherein, both said overrunning clutches and said driven shaft are co-axially located with respect to each other;
an elastically extensible reversing mechanism; and,
wherein, said elastically extensible reversing mechanism is functionally connected to said overrunning clutches such that, when not extended, said outer driving shells of said overrunning clutches counter-rotate but, while being extended, said outer driving shells can both rotate in the same direction.

18. The reciprocating action drive of claim 17 wherein said elastically extensible reversing mechanism comprises an elastomer element.

19. The reciprocating action drive of claim 17, wherein, at least one of said overrunning clutches is a magnetically hinged overrunning clutch.
